(19) United States
(12) Patent Application Publication
(10) Pub. No.: US 2025/0010851 A1
(43) Pub. Date: Jan. 9, 2025

(54) VEHICLE CONTROL DEVICE

(71) Applicant: TOYOTA JIDOSHA KABUSHIKI KAISHA, Toyota-shi (JP)

(72) Inventors: Naoki IGUCHI, Toyota-shi (JP); Tomoki SOMIYA, Okazaki-shi (JP)

(73) Assignee: TOYOTA JIDOSHA KABUSHIKI KAISHA, Toyota-shi (JP)

(21) Appl. No.: 18/755,157

(22) Filed: Jun. 26, 2024

(30) Foreign Application Priority Data
Jul. 5, 2023 (JP) 2023-110888

(51) Int. Cl. B60W 30/09; B60W 50/14

(52) U.S. Cl. CPC B60W 30/09; B60W 50/14; B60W 2050/146; B60W 2420/403; B60W 2420/408; B60W 2554/802

(57) ABSTRACT

A vehicle control device comprising an obstacle detection device that detects an obstacle in front of an own vehicle, a following vehicle detection device that detects a following vehicle behind the own vehicle, a notification device that notifies a driver that there is a risk of collision when it is determined that there is a risk that the own vehicle will collide with the obstacle detected by the obstacle detection device, and an information device that informs the driver, when it is determined that the following vehicle detected by the following vehicle detection device is approaching the own vehicle, that the following vehicle is approaching the own vehicle, and the notification device is configured to advance a timing of notifying the driver that there is the risk of the collision.

### CROSS-REFERENCE TO RELATED APPLICATION

This application claims priority to Japanese Patent Application No. JP2023-110888 filed on Jul. 5, 2023, the content of which is hereby incorporated by reference in its entirety into this application.

### BACKGROUND

### 1. Technical Field

The present disclosure relates to a vehicle control device for a vehicle such as an automobile.

### 2. Description of the Related Art

As a control device for a vehicle such as an automobile, a collision prevention device is known that, when an obstacle is detected in front of the vehicle, determine whether or not the vehicle is likely to collide with the obstacle and, when there is a risk of collision, apply braking force to the vehicle by automatic braking to prevent the collision.

For example, in Japanese Patent Application Laid-open No. 2010-52546, a collision prevention device is described that, when a possibility of a collision between an own vehicle and an obstacle in front of it is predicted and a following vehicle is detected, advances a timing of automatic braking compared to when a following vehicle is not detected, and controls braking force of the automatic braking to a level that prevents a rear-end collision with the following vehicle.

In addition, as a control device for a vehicle such as an automobile, an information device is known that, when a following vehicle is detected behind an own vehicle and it is determined that the following vehicle is approaching the own vehicle, informs a driver that the following vehicle is approaching the own vehicle. According to this type of control device, when a following vehicle is approaching the own vehicle, the driver can recognize earlier that the following vehicle is behind the own vehicle, as compared to where it is not informed that the following vehicle is approaching the own vehicle.

When a following vehicle is detected behind the own vehicle and it is informed by displaying on an information device that the following vehicle is approaching the own vehicle in a situation where an obstacle is detected in front of the own vehicle, a driver pays attention to the information displayed on the information device. Therefore, there is a risk that the driver will be delayed in recognizing the obstacle in front of the own vehicle.

### SUMMARY

The present disclosure provides a vehicle control device which is improved to reduce the risk that a driver is delayed in recognizing an obstacle in front of an own vehicle when the obstacle is detected in front of the own vehicle and a following vehicle is detected behind the own vehicle.

According to the present disclosure, a vehicle control device is provided which comprises an obstacle detection device that detects an obstacle in front of an own vehicle, a following vehicle detection device that detects a following vehicle behind the own vehicle, a information device that informs a driver that there is a risk of collision when it is determined that there is a risk that the own vehicle will collide with the obstacle detected by the obstacle detection device, and an information device that notifies the driver, when it is determined that the following vehicle detected by the following vehicle detection device is approaching the own vehicle, that the following vehicle is approaching the own vehicle.

The notification device is configured to advance a timing of informing the driver that there is the risk of the collision when the information device is informing that the following vehicle is approaching the own vehicle, as compared to when the notifying device is not informing that the following vehicle is approaching the own vehicle.

According to the present disclosure, the timing of notifying the driver that there is the risk of the collision is advanced when the information device is informing that the following vehicle is approaching the own vehicle, as compared to when the information device is not informing that the following vehicle is approaching the own vehicle.

Therefore, it is possible to make the driver aware of the possibility of the collision at an earlier stage when the information device is informing that the following vehicle is approaching the own vehicle, as compared to when the information device is not informing that the following vehicle is approaching the own vehicle. Accordingly, it is possible, when an obstacle is detected in front of the own vehicle and a following vehicle is detected behind the own vehicle, to reduce the possibility that the driver is delayed in recognizing that there is the obstacle in front of the own vehicle.

In one aspect of the present disclosure, the information device is configured to inform the driver that the following vehicle is approaching the own vehicle by displaying information on a display device, and the notification device is configured to display on the display device that there is the risk of the collision when the display device indicates that the following vehicle is approaching the own vehicle.

In another aspect of the present disclosure, the display device is a mirror device for rear confirmation that is configured to be able to inform the driver of information.

Further, in another aspect of the present disclosure, the own vehicle is equipped with a collision prevention device that performs collision prevention control to reduce the risk of the collision with the obstacle by automatic braking when it is determined that there is the risk of the own vehicle colliding with the obstacle detected by the obstacle detection device, and the collision prevention device is configured to start the automatic braking earlier when the information device is informing that the following vehicle is approaching the own vehicle as compared to when the information device is not informing that the following vehicle is approaching the own vehicle.

Further, in another aspect of the present disclosure, the collision prevention device is configured to advance a timing of notifying the driver that the automatic braking may start when the information device is informing that the following vehicle is approaching the own vehicle as compared to when the information device is not informing that the following vehicle is approaching the own vehicle.

Other objects, other features and attendant advantages of the present disclosure will be readily understood from the description of the embodiments of the present disclosure described with reference to the following drawings.

### BRIEF DESCRIPTION OF THE DRAWINGS

FIG. 1 is a schematic configuration diagram showing an embodiment of a vehicle control device according to the present disclosure.

FIG. 2 is a flowchart showing a collision prevention control routine in the embodiment.

FIG. 3 is a flowchart showing a rear approach control routine in the embodiment.

FIG. 4 is a flowchart showing a flag setting control routine in the embodiment.

FIG. 5 is a diagram illustrating a situation where there is a risk that an own vehicle will collide with an obstacle in front of the own vehicle and there is a following vehicle.

### DESCRIPTION OF THE PREFERRED EMBODIMENT

A vehicle control device according to an embodiment of the present disclosure will be described in detail below with reference to the accompanying drawings.

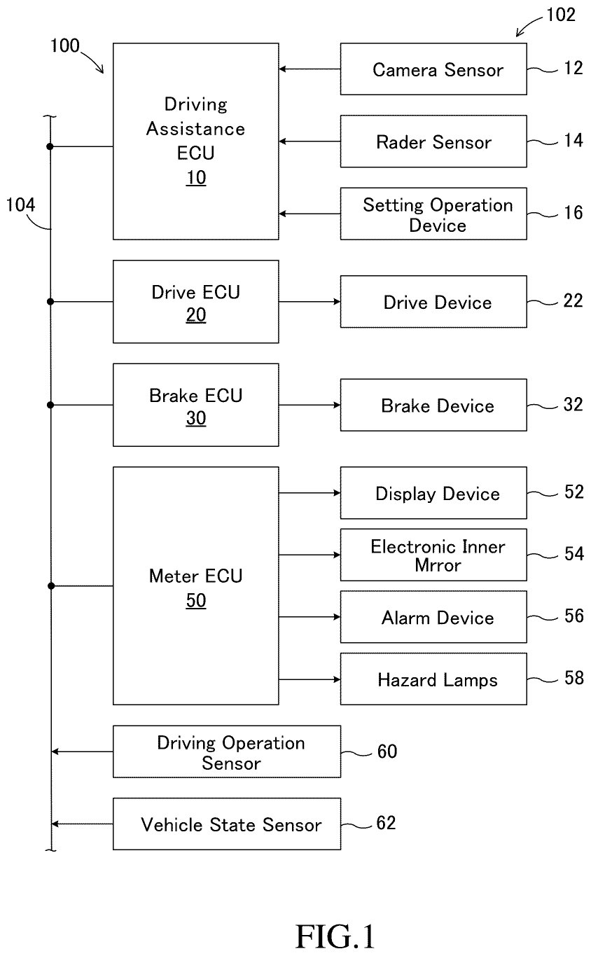

As shown in FIG. 1, a vehicle control device 100 according to an embodiment of the present disclosure is applied to a vehicle 102 and includes a driving assistance ECU 10. The vehicle 102 may be a vehicle capable of autonomous driving. As shown in FIG. 1, the vehicle 102 includes a drive ECU 20, a brake ECU 30, and a meter ECU 50. ECU means an electronic control unit having a microcomputer as its main part. In the following description, the vehicle 102 is referred to as own vehicle 102 as needed to distinguish it from other vehicles.

A microcomputer of each ECU includes a CPU, a ROM, a RAM, a readable and writable nonvolatile memory (N/M), an interface (I/F), and the like. The CPU implements various functions by executing instructions (programs, routines) stored in the ROM. Furthermore, these ECUs are connected to each other via a CAN (Controller Area Network) 104 so as to be able to exchange data (communicate). Therefore, detected values of sensors (including switches) connected to a specific ECU are transmitted to other ECUs as well.

The driving assistance ECU 10 is a central control unit that performs driving assistance control for the vehicle such as collision prevention control, lane keeping control. A camera sensor 12 and a radar sensor 14 are connected to the driving assistance ECU 10. The camera sensor 12 includes four camera sensors that take images of the front, rear, right side, and left side, but is not limited to four camera sensors. The radar sensor 14 includes five radar sensors that detect three-dimensional objects existing in the front area, right front area, left front area, right rear area, and left rear area and acquire information on the three-dimensional objects. However, the number is not limited to five.

The camera sensor 12 and the radar sensor 14 function as an obstacle detection device that detects obstacles in front of the vehicle (own vehicle) 102. Further, the camera sensor 12 and the radar sensor 14 function as a following vehicle detection device that detects a following vehicle behind the vehicle 102.

Each camera of the camera sensor 12 analyzes image data obtained by photographing, acquires information on targets such as white lines on a road and other vehicles, and supplies information on the targets to the driving assistance ECU 10 at predetermined intervals.

Each radar sensor of the radar sensor 14 acquires information representing a distance between the own vehicle and the three-dimensional object, a relative speed between the own vehicle and the three-dimensional object, a relative position (direction) of the three-dimensional object with respect to the own vehicle, etc. at predetermined time intervals. and supplies it to the driving assistance ECU 10.

Further, a setting operation device 16 is connected to the driving assistance ECU 10, and the setting operation device 16 is provided at a position to be operated by a driver. Although not shown in FIG. 1, The setting operation device 16 includes a collision prevention control switch, and the driving assistance ECU 10 executes collision prevention control when the collision prevention control switch is on. The setting operation device 16 includes a rear approach control switch, and the driving assistance ECU 10 executes rear approach control when the rear approach control switch is on. The collision prevention control and the rear approach control will be explained in detail later.

The drive ECU 20 is connected to a drive device 22 that accelerates the vehicle 102 by applying driving force to drive wheels (not shown in FIG. 1). The drive ECU 20 normally controls the drive device 22 so that the driving force generated by the drive device 22 changes according to a driving operation by the driver, and when the drive ECU 20 receives a command signal from the driving assistance ECU 10, the drive ECU 20 controls the drive device 22 based on the command signal.

Note that the drive device 22 is not limited to a combination of an internal combustion engine and an automatic transmission. That is, the drive device 22 may be any drive device known in the art such as a combination of an internal combustion engine and a continuously variable transmission, a so-called hybrid system that is a combination of an internal combustion engine and a motor, a so-called plug-in hybrid system, a combination of a fuel cell and a motor, or a motor or motors.

The brake ECU 30 is connected to a brake device 32 that decelerates the vehicle 102 by applying braking force to wheels (not shown in FIG. 1). The brake ECU 30 normally controls the brake device 32 so that the braking force generated by the brake device 32 changes according to a braking operation by the driver, and, when the brake ECU 30 receives a command signal from the driving assistance ECU 10, the brake ECU 30 performs automatic braking by controlling the brake device 32 based on a command signal. Therefore, the brake ECU 30 and the brake device 32 function as an automatic brake device. Note that when braking force is applied to the wheels, brake lamps not shown in FIG. 1 are lit.

The meter ECU 50 is connected to a display device 52 that displays status of the control by the driving assistance ECU 10 and, if there is a risk that the own vehicle will collide with another vehicle, a visual alarm indicating the risk. The display device 52 may be, for example, a head-up display or a multi-information display on which meters and various pieces of information are displayed, or may be a display of a navigation device (not shown).

Furthermore, an electronic inner mirror 54, an alarm device 56, and hazard lamps 58 are connected to the meter ECU 50. The electronic inner mirror 54 is a mirror device for rear confirmation that is configured to display an image taken by the camera that photographs the rear of the own vehicle, and to display information to be provided to the driver as necessary. The alarm device 56 issues an alarm. The alarm device 56 may be any of an alarm device that issues a visual alarm such as a display or an alarm lamp, an alarm device that issues an auditory alarm such as an alarm buzzer, or an alarm device that issues a tactile alarm such as a vibration of a seat, or any combination thereof.

The driving operation sensor 60 and the vehicle state sensor 62 are connected to the CAN 104. Information detected by the driving operation sensor 60 and the vehicle state sensor 62 (referred to as sensor information) is transmitted to the CAN 104. The sensor information transmitted to the CAN 104 can be appropriately used in each ECU. Note that the sensor information may be information of a sensor connected to a specific ECU, and may be transmitted from the specific ECU to the CAN 104.

The driving operation sensor 60 includes a driving operation amount sensor that detects an operation amount on an accelerator pedal, a braking operation amount sensor that detects master cylinder pressure or depression force on a brake pedal, and a brake switch that detects whether or not the brake pedal is operated. Further, the driving operation sensor 60 includes a steering angle sensor that detects a steering angle, a steering torque sensor that detects a steering torque, and the like.

The vehicle state sensor 62 includes a vehicle speed sensor that detects a vehicle speed of the vehicle 102, a longitudinal acceleration sensor that detects a longitudinal acceleration of the vehicle, a lateral acceleration sensor that detects a lateral acceleration of the vehicle, and a yaw rate sensor that detects a yaw rate of the vehicle, etc.

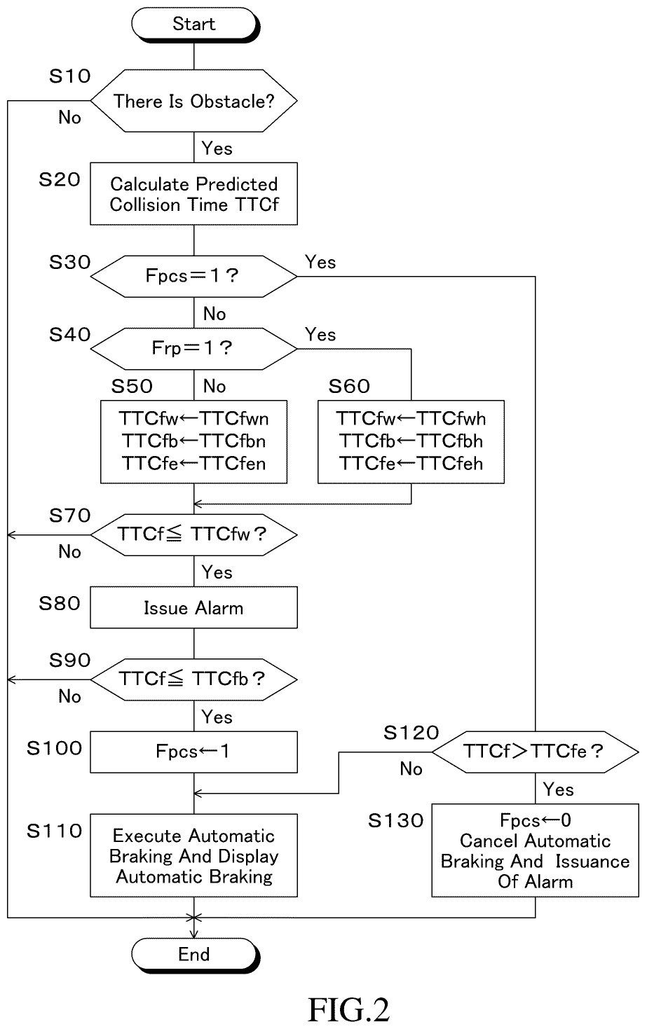

In the embodiment, the ROM of the driving assistance ECU 10 stores a collision prevention control program corresponding to the flowchart shown in FIG. 2. The CPU executes collision prevention control according to the program while the collision prevention control switch is on. Note that in the following description, the collision prevention control will be referred to as the PCS control.

As will be explained in detail later, when it is determined that there is a risk that the own vehicle 102 will collide with an obstacle detected by the obstacle detection device, the driving assistance ECU 10, the meter ECU 50, the display device 52, and the alarm device 56 function as a notification device that notifies the driver that there is the risk of the collision.

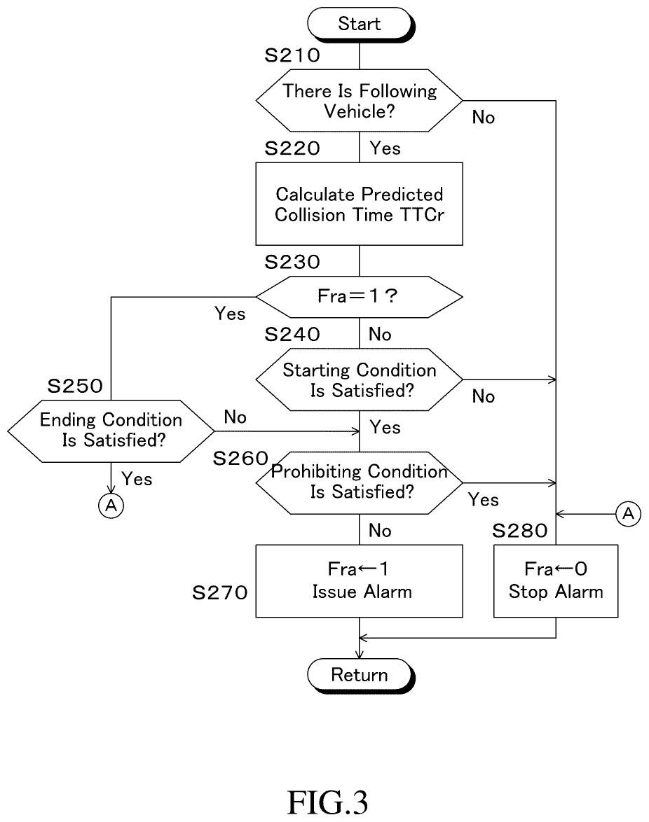

The ROM of the driving assistance ECU 10 stores a rear approach control program corresponding to the flowchart shown in FIG. 3, and the CPU executes the rear approach control according to the program while the rear approach control switch is on. The rear approach control is a control that, when a following vehicle is approaching the own vehicle, informs the driver that the following vehicle is approaching the own vehicle to alert the driver.

As will be explained in detail later, when it is determined that the following vehicle detected by the following vehicle detection device is approaching the own vehicle 102, the driving assistance ECU 10, the meter ECU 50, the display device 52, the electronic inner mirror 54, and the warning device 56 function as an information device that informs the driver that a following vehicle is approaching the own vehicle.

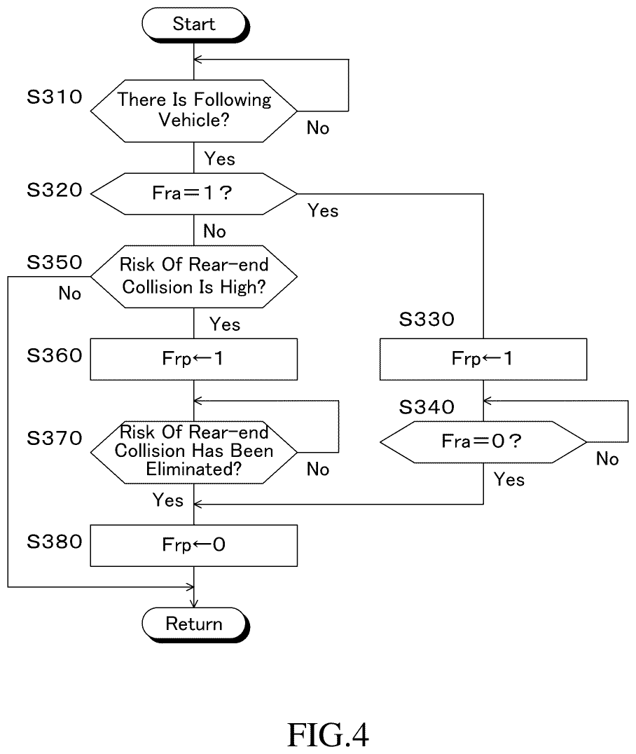

Further, the ROM of the driving assistance ECU 10 stores a flag setting control program corresponding to the flowchart shown in FIG. 4, and the CPU performs the flag setting control according to the program while the rear approach control switch is on. The flag setting control is a control for setting a flag Frp indicating whether or not reference values for determining a magnitude of a predicted collision time TTCf should be increased.

### <PCS Control Routine> (FIG. 2)

First, in step S10, the CPU determines whether or not there is an obstacle in front of the vehicle 102, that is, whether the obstacle detection device has detected an obstacle in front of the vehicle 102. When a negative determination is made, the PCS control ends once, and when an affirmative determination is made, the PCS control proceeds to step S20.

In step S20, the CPU calculates a predicted collision time TTCf, which is a predicted time until the own vehicle 102 collides with the obstacle. The predicted collision time TTCf is calculated according to the following equation (1) based on a distance Drf between the obstacle and the own vehicle and a relative speed Vrf of the own vehicle with respect to the obstacle based on a detection result by the obstacle detection device. The predicted collision time TTCf is an index representing a possibility that the own vehicle will collide with the obstacle, and the smaller the predicted collision time, the higher the possibility (risk) that the own vehicle will collide with the obstacle.

TTCf=Drf/Vrf (1)

In step S30, the CPU determines whether or not the flag Fpcs is 1, that is, whether or not the automatic braking is being executed under the PCS control. When an affirmative determination is made, the PCS control proceeds to step S120, and when a negative determination is made, the PCS control proceeds to step S40. Note that the flag Fpcs is initialized to 0 at the start of the PCS control prior to step S10.

In step S40, the CPU determines whether or not the flag Frp set according to the flowchart shown in FIG. 4, which will be described later, is 1, i.e. whether or not the reference values for determining the magnitude of the predicted collision time TTCf should be increased. When a negative determination is made, in step S50, the reference values TTCfw, TTCfb, and TTCfe are set to standard values TTCfwn, TTCfbn, and TTCfen (positive constants), respectively. On the other hand, when an affirmative determination is made, in step S60, the reference values TTCfw, TTCb and TTCfe are set to values TTCfwh, TTCfbh and TTCfeh (positive constants) larger than the standard values TTCfwn, TTCfbn and TTCfen, respectively.

In step S70, the CPU determines whether or not the predicted collision time TTCf is less than or equal to the alarm reference value TTCfw, that is, determines whether or not it is necessary to issue an alarm that there is a possibility that the own vehicle will collide with the obstacle. When a negative determination is made, the PCS control ends once, and when an affirmative determination is made, the PCS control proceeds to step S80.

In step S80, the CPU activates the alarm device 58 to issue an alarm that there is a risk that the own vehicle will collide with the obstacle, and also issues an alarm to the electronic interior mirror 54 that the own vehicle is likely to collide with the obstacle. In particular, when an affirmative determination is made in step S40, the alarm device 56 is activated so as to notify the driver that there is a possibility that the automatic braking will start.

In step S90, the CPU determines whether or not the predicted collision time TTCf is less than or equal to the braking reference value TTCfb, that is, determines whether or not the automatic braking is necessary. When a negative determination is made, the PCS control ends once, and when an affirmative determination is made, a flag Fpcs is set to 1 in step S100.

In step S110, the CPU calculates a PCS required deceleration Gpcs as a target deceleration for preventing the collision, and outputs a PCS brake command to the brake ECU 30 to control a deceleration of the own vehicle 102 to the PCS required deceleration Gpcs. Therefore, the brake device 32 is controlled by the brake ECU 30 so that a deceleration of the own vehicle 102 becomes the PCS required deceleration Gpcs, thereby the automatic braking is executed. Further, the CPU cancels the notification that the automatic brake may start, and displays on the display device 52 that the automatic brake is being executed.

The PCS required deceleration Gpcs is calculated as follows. A deceleration of the own vehicle is represented by Gb (<0) and a time until the own vehicle stops is represented by t, then a traveling distance X until the own vehicle stops can be expressed by the following equation (2).

X=Vrf·t−(½)·Gb·t² (2)

Further, the time t until the own vehicle stops can be expressed by the following equation (3).

t=−Vrf/Gb (3)

Therefore, by substituting the time t calculated by the equation (3) for the time t in the equation (2), the traveling distance X until the own vehicle stops can be expressed by the following equation (4).

X=−V²/(2Gb) (4)

In order to stop the own vehicle a distance (>0) β in front of the obstacle, the deceleration Gb may be calculated by setting the traveling distance X to a distance Drf-β obtained by subtracting the distance β from the distance Drf detected by the obstacle detection device. The PCS required deceleration Gpcs is set to a sign-inverted value of the deceleration Gb calculated as described above.

In step S120, the CPU determines whether or not the predicted collision time TTCf is greater than the end reference value TTCfe. When a negative determination is made, the PCS control proceeds to step S110, and when an affirmative determination is made, the PCS control proceeds to step S130.

In step S130, the CPU resets the flag Fpcs to 0, cancels the automatic braking and the issuance of the alarm, and displays on the display device 52 that the automatic braking has been canceled.

### <Rear Approach Control Routine> (FIG. 3)

First, in step S210, the CPU determines whether or not there is a following vehicle behind the own vehicle 102, that is, whether or not a following vehicle is detected by the following vehicle detection device. When a negative determination is made, the rear approach control proceeds to step S280, and when an affirmative determination is made, the rear approach control proceeds to step S220.

In step S220, the CPU calculates a predicted collision time TTCr which is a predicted time until the following vehicle collides with the own vehicle 102, based on a distance Drr between the own vehicle 102 and the following vehicle and a relative speed Vrr of the following vehicle with respect to the own vehicle based on the detection result by the following vehicle detection device. The predicted collision time TTCr is calculated according to the following equation (5) based on the distance Drr and the relative speed Vrr of the following vehicle with respect to the own vehicle. The predicted collision time TTCr is an index representing a possibility that the following vehicle will collide with the own vehicle, and the smaller the predicted collision time, the higher the possibility (risk) that the following vehicle will collide with the own vehicle.

TTCr=Drr/Vrr (5)

In step S230, the CPU determines whether or not a flag Fra is 1, that is, whether or not a alarm has been issued indicating that there is a risk that the following vehicle will collide with the own vehicle. When an affirmative determination is made, the rear approach control proceeds to step S250, and when a negative determination is made, the rear approach control proceeds to step S240. Note that the flag Fra is initialized to 0 at the start of rear approach control prior to step S210.

In step S240, the CPU determines whether or not a condition for starting issuance of the alarm indicating that there is the risk that the following vehicle will collide with the own vehicle is satisfied. When a negative determination is made, the rear approach control proceeds to step S280, and when an affirmative determination is made, the rear approach control proceeds to step S260.

In this step S240, an affirmative determination may be made when the following condition 1 or 2 is satisfied.
Condition 1: The predicted collision time TTCr is less than or equal to an alarm start reference time TTCrs (a positive constant).
Condition 2: The distance Drr between the following vehicle and the own vehicle is less than or equal to an alarm start reference distance Drrs (a positive constant).

In step S250, the CPU determines whether or not a condition for ending the issuance of the alarm indicating that there is the risk that the following vehicle will collide with the own vehicle is satisfied. When an affirmative determination is made, the rear approach control proceeds to step S280, and when a negative determination is made, the rear approach control proceeds to step S260.

In this step S250, an affirmative determination may be made when the following condition 3 or 4 is satisfied.
Condition 3: The predicted collision time TTCr is larger than or equal to an alarm end reference time TTCre (a positive constant larger than TTCrs).
Condition 4: The distance Drr between the following vehicle and the own vehicle is equal to or larger than an alarm end reference distance Drre (a positive constant larger than Drrs) for ending the alarm.

In this step S260, the CPU determines whether or not a condition for prohibiting the issuance of the alarm indicating that there is the risk that the following vehicle will collide with the own vehicle is satisfied. When an affirmative determination is made, the rear approach control proceeds to step S280, and when a negative determination is made, the rear approach control proceeds to step S270.

In step S260, an affirmative determination may be made when the following condition 5 or 6 is satisfied.
Condition 5: Braking operation is performed by the driver.
Condition 6: The blinker switch is on.

In step S270, when the flag Fra is 0, the CPU sets the flag Fra to 1. Further, the CPU issues the alarm that there is the risk that the following vehicle will collide with the own vehicle by displaying the electronic interior mirror 54 and activating the alarm device 56, and causes the hazard lamps 58 to blink at short blinking intervals. This alerts a driver of the following vehicle.

In step S280, the CPU resets the flag Fra to 0. Moreover, when the alarming is being executed, the CPU stops the operation of the electronic inner mirror 54 and the alarm device 56, and also stops the blinking of the hazard lamps 58.

### <Flag Setting Control Routine> (FIG. 4)

First, in step S310, the CPU determines whether or not there is a following vehicle behind the own vehicle 102, similarly to step S210. When a negative determination is made, step S310 is repeatedly executed, and when an affirmative determination is made, the flag setting control proceeds to step S320.

In step S320, similarly to step S230, the CPU determines whether or not the flag Fra is 1, that is, whether or not an alarm has been issued indicating that there is the risk that the following vehicle will collide with the own vehicle. When a negative determination is made, the flag setting control proceeds to step S350, and when an affirmative determination is made, the flag Frp is set to 1 in step S330.

In step S340, the CPU determines whether or not the flag Fra is 0, that is, whether or not the issuance of the alarm indicating that there is the risk that the following vehicle will collide with the own vehicle has ended. When a negative determination is made, step S340 is repeatedly executed, and when an affirmative determination is made, the flag setting control proceeds to step S380.

In step S350, the CPU determines whether or not there is a high risk that the following vehicle will collide with the own vehicle from behind. When a negative determination is made, the flag setting control ends once, and when an affirmative determination is made, the flag Frp is set to 1 in step S360.

In this step S350, an affirmative determination may be made when the following condition 7 or 8 is satisfied.
Condition 7: The predicted collision time TTCr is longer than the alarm start reference time TTCrs, but the rate of decrease in the distance Drr is larger than or equal to a reference decrease rate Drrd (a positive constant).
Condition 8: The distance Drr between the following vehicle and the own vehicle is larger than the alarm start reference distance Drrs, but the rate of decrease in the predicted collision time TTCr is larger than or equal to a reference decrease rate TTCrd (a positive constant).

In step S370, the CPU determines whether or not the risk that the following vehicle will collide with the own vehicle has been eliminated. When a negative determination is made, step S370 is repeatedly executed, and when an affirmative determination is made, the flag Frp is reset to 0 in step S380.

### Operation of Embodiment

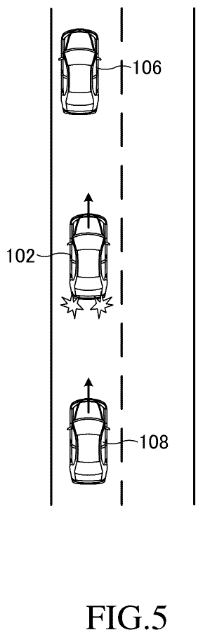

Next, as shown in FIG. 5, the operation of the embodiment will be described with respect to a case where there is a risk that the own vehicle 102 will collide with an obstacle 106 in front of it such as a stopped vehicle and there is a following vehicle 108.

### C1: When the Following Vehicle is not Approaching the Own Vehicle

Since negative determinations are made in steps S230 and S240 in FIG. 3, the flag Fra is maintained at 0 in step S280. Therefore, since negative determinations are made in steps S320 and S350 in FIG. 4, the flag Frp is maintained at 0.

Therefore, in steps S30 and S40 in FIG. 2, negative determinations are made, so that in step S50, the reference values TTCfw, TTCfb, and TTCfe are set to the standard values TTCfwn, TTCfbn, and TTCfen, respectively, and step S70 and subsequent steps are executed. Note that since the following vehicle is not approaching the own vehicle, the alarm (S80) is not issued and the automatic braking (S110) is not performed.

### C2: When the Following Vehicle is Approaching the Own Vehicle

First, in steps S230, S240 and S260 in FIG. 3, a negative determination, an affirmative determination, and a negative determination are made, respectively, so that the flag Fra is set to 1 in step S270. Thereafter, affirmative and negative determinations are made in steps S230 and S250, respectively, until the condition for ending the issuance of the alarm (S250) indicating that there is the risk that the following vehicle will collide with the own vehicle is satisfied. Therefore, by executing step S270, the flag Fra is maintained at 1. Further, the alarm is issued to the effect that there is the risk that the following vehicle will collide with the own vehicle, and a driver of the following vehicle is alerted by blinking the hazard lamps 58 at short blinking intervals.

Since an affirmative determination is made in step S320 in FIG. 4, the flag Frp is set to 1 in step S330, and is maintained at 1 until the flag Fra becomes 0, that is, until an affirmative determination is made in step S340.

In step S30 in FIG. 2, a negative determination is made, but in step S40, an affirmative determination is made, so that in step S60, the reference values TTCfw, TTCfb, and TTCfe are set to the values TTCfwh, TTCfbh, and TTCfeh that are larger than the standard values TTCfwn, TTCfbn, and TTCfen, respectively, and steps S70 to S130 are executed.

As a result, the determination in step S70 becomes affirmative earlier as compared to where the reference value TTCfw is the standard value TTCfwn. Therefore, when the information device is informing that the following vehicle is approaching the own vehicle, the timing at which the driver is notified of the possibility of a collision becomes earlier as compared to when the information device is not informing that the following vehicle is approaching the own vehicle.

Therefore, when the information device is informing the driver that the following vehicle is approaching the own vehicle, the driver can recognize that there is the risk of the collision at earlier stage as compared to when the information device is not informing that the following vehicle is approaching the own vehicle. Accordingly, when an obstacle is detected in front of the own vehicle and a following vehicle is detected behind the own vehicle, it is possible to reduce the possibility that the driver will be delayed in recognizing that there is the obstacle in front of the vehicle.

In addition, there is a tendency for the driver to be delayed in recognizing that there is an obstacle in front of the own vehicle when a display device displays that a following vehicle is approaching the own vehicle and the driver pays attention to the display in a situation where there is an obstacle in front of the own vehicle and the following vehicle is approaching the own vehicle.

According to the embodiment, the driver is informed that the following vehicle is approaching the own vehicle by displaying it on the electronic inner mirror 54 serving as a display device. Furthermore, when the electronic interior mirror displays that the following vehicle is approaching the own vehicle (S40), the electronic interior mirror displays that there is the risk of collision (S80). Therefore, even when the driver is checking the following vehicle using the electronic interior mirror, the driver can easily recognize that there is an obstacle in front of the own vehicle, so that it is possible to reduce the possibility that there will be a delay in recognizing the presence of the obstacle.

Further, the determination in step S90 becomes affirmative earlier as compared to where the reference value TTCfb is the standard value TTCfbn. Therefore, when it is informed that the following vehicle is approaching the own vehicle (S40), the automatic braking starts earlier as compared to when it is not informed that the following vehicle is approaching the own vehicle. (S110). Accordingly, even if there is a delay in the driver recognizing that there is an obstacle in front of the own vehicle, the possibility of preventing the own vehicle from colliding with the obstacle can be increased.

Furthermore, the determination in step 70 becomes affirmative earlier as compared to where the reference value TTCfw is the standard value TTCfwn. Therefore, when it is informed that the following vehicle is approaching the own vehicle (S40), the advance notice of the start of the automatic braking is executed earlier as compared to when it is not informed that the following vehicle is approaching the own vehicle (S80). Accordingly, the driver can recognize the start of the automatic braking at an earlier stage.

Although the present disclosure has been described in detail with reference to the specific embodiment, it will be apparent to those skilled in the art that the present disclosure is not limited to the above-described embodiment, and various other embodiments are possible within the scope of the present disclosure.

For example, in the above-described embodiment, the electronic inner mirror 54 is a common display device that displays that a following vehicle is approaching the own vehicle and that there is a risk that the own vehicle will collide with an obstacle in front of the own vehicle. However, the common display device may be the display device 52, or may be an inner mirror in which a reflective inner mirror is provided with a display.

In the above-described embodiment, when the driver is informed that the following vehicle is approaching the own vehicle, the start of the automatic braking and its advance notice are executed earlier as compared to when the driver is not informed that the following vehicle is approaching the own vehicle. However, advancing of at least one of starting the automatic brake and its advance notice may be omitted.

Further, in the above-described embodiment, the Flag setting control according to the flowchart shown in FIG. 4 is executed. However, the flag setting control may be omitted and when a negative determination is made in step S240, step S350 may be executed, and when an affirmative determination is made in step S350, the rear approach control may proceed to step S260, and a negative determination is made, the rear approach control may proceed to step S280.

What is claimed is:

1. A vehicle control device comprising an obstacle detection device that detects an obstacle in front of an own vehicle, a following vehicle detection device that detects a following vehicle behind the own vehicle, a notification device that notifies a driver that there is a risk of collision when it is determined that there is a risk that the own vehicle will collide with the obstacle detected by the obstacle detection device, and an information device that informs the driver, when it is determined that the following vehicle detected by the following vehicle detection device is approaching the own vehicle, that the following vehicle is approaching the own vehicle, wherein
the notification device is configured to advance a timing of informing the driver that there is the risk of the collision when the information device is informing that the following vehicle is approaching the own vehicle, as compared to when the notifying device is not informing that the following vehicle is approaching the own vehicle.

2. The vehicle control device according to claim 1, wherein the information device is configured to inform the driver that the following vehicle is approaching the own vehicle by displaying information on a display device, and the notification device is configured to display on the display device that there is the risk of the collision when the display device indicates that the following vehicle is approaching the own vehicle.

3. The vehicle control device according to claim 2, wherein the display device is a mirror device for rear confirmation that is configured to be able to inform the driver of information.

4. The vehicle control device according to claim 1, wherein the own vehicle is equipped with a collision prevention device that performs collision prevention control to reduce the risk of the collision with the obstacle by automatic braking when it is determined that there is the risk of the own vehicle colliding with the obstacle detected by the obstacle detection device, and the collision prevention device is configured to start the automatic braking earlier when the information device is informing that the following vehicle is approaching the own vehicle as compared to when the information device is not informing that the following vehicle is approaching the own vehicle.

5. The vehicle control device according to claim 4, wherein the collision prevention device is configured to advance a timing of notifying the driver that the automatic braking may start when the information device is informing that the following vehicle is approaching the own vehicle as compared to when the information device is not informing that the following vehicle is approaching the own vehicle.
